(19) United States
(12) Patent Application Publication
(10) Pub. No.: US 2011/0214663 A1
(43) Pub. Date: Sep. 8, 2011

(54) FUEL ELEMENT AND ASSOCIATED PORTABLE STOVE SYSTEMS AND METHODS OF MANUFACTURE

(76) Inventor: Adam Cox, Draper, UT (US)

(21) Appl. No.: 13/042,241

(22) Filed: Mar. 7, 2011

Related U.S. Application Data
(60) Provisional application No. 61/311,167, filed on Mar. 5, 2010.

(51) Int. Cl. A47J 37/07; C10L 5/00; C10L 5/36; B29C 43/02; B29C 55/18

(52) U.S. Cl. 126/25 R; 44/606; 44/530; 44/541; 264/319; 264/157; 264/175; 264/145

(57) ABSTRACT

According to one embodiment, a portable fuel system includes a container that includes a closed end and an open end. The system also includes a fuel element that includes a compressed homogenous mixture of a cellulose-containing material and a hardened wax material. The fuel element is removably positionable within the container. The system also includes a spacer that is positionable within the container between the closed end of the container and the fuel element. The spacer supports the fuel element on the closed end such that air is flowable between the fuel element and the closed end. The system further includes a cooking surface that is couplable to the open end of the container.

### CROSS-REFERENCE TO RELATED APPLICATION

This application claims the benefit of U.S. Provisional Patent Application No. 61/311,167, filed Mar. 5, 2010, which is incorporated herein by reference.

### FIELD

The present disclosure relates generally to portable stove systems, and more particularly to fuel elements that generate heat for portable stove systems.

### BACKGROUND

Portable stove systems provide temporary heating and cooking functionality in many types of indoor and outdoor settings. Some portable stove systems include a container, a combustible material positioned within the container, and a cooking surface placed above the container. After ignition, the combustible material provides heat to the cooking surface, which is used to heat food or liquid placed on the cooking surface.

Generally, the combustible material includes a combination of wax and cellulose-containing material, such as wood shavings. The cellulose-containing material is mixed with the wax in a heated state to form a combustible material mixture. In certain portable stove systems, the combustible material mixture is poured directly into the container in a heated state and allowed to cool within the container over time. The combustible material mixture is often compacted within the container until firm within the container. In other words, the mixture is compacted and formed against the wall of the container. When the mixture cools and hardens, the mixture is fixedly secured to the container. Commonly, a wick is positioned within the mixture to facilitate ignition of the mixture. After the combustible material is fully combusted, the portable stove system is discarded. In other portable stove systems, the combustible material is formed into a disk that fits within the container.

Although conventional portable stove systems provide useful features and advantages, they can suffer from several shortcomings particularly with regard to the composition, configuration, and manufacturability of the combustible material. The wax component of the combustible material used in conventional portable stove systems is not food-grade wax. Accordingly, undesirable impurities can be absorbed into the cooked food when using non-food grade wax in the combustible material. Further, the combustible material used in conventional portable stove systems is not configured for optimum portability and ignitibility. Also, conventional processes used to manufacture the combustible material of known portable stove systems are not capable with adequately and efficiently meeting the demands associated with mass-production.

### SUMMARY

The subject matter of the present application has been developed in response to the present state of the art, The subject matter of the present application has been developed in response to the present state of the art, and in particular, in response to the problems and needs in the art that have not yet been fully solved by currently available portable stove systems and associated combustible material. Accordingly, the subject matter of the present application has been developed to provide a fuel element made from combustible material for a portable stove system that overcomes at least some of the shortcomings of the prior art.

Described herein are various embodiments of a fuel element for a portable stove system and associated methods of making the same. In certain embodiments, the fuel element is highly modular, portable, and compact, is easily placeable within and removable from a portable stove system container, is easily ignitable, produces a prolonged burn while providing a high heat level, is mass-producible, and is made from food-safe components. Generally, in some embodiments, the fuel element is made from a highly compressed combustible material, such as a combination of a wax material and cellulose-containing material. The fuel element can be a plate-like element having a substantially circular-shaped, ovular-shaped, or polygonal-shaped outer periphery. In some implementations, the fuel element is substantially disk-shaped. As defined herein, a disk shape has two opposing major surfaces separated from each other by a thickness where the thickness is substantially less than a major dimension of the major surfaces. By definition, the outer peripheries of the major surfaces can define any of various circular and non-circular shapes. The fuel element can include a combustible fibrous outer covering, such as a wax paper, for convenient packaging and facilitating ignition of the combustible material.

According to one specific embodiment, a fuel element for a portable stove system includes a homogenous mixture of a cellulose-containing material and a hardened wax material. The homogenous mixture has a substantially disk shape. The fuel element also includes a cover wrapped about the homogenous mixture. The cover can include a combustible wax paper. The cellulose-containing material may be hard wood shavings and the hardened wax material may be a naturally occurring wax. The naturally occurring wax can be beeswax.

Generally, the fuel element can be manufactured using a process more conducive to mass-production than known processes. In one embodiment, fuel elements are made by forming an elongate column of compressed combustible material and slicing the column into multiple, individual fuel elements. In another embodiment, fuel elements are made by rolling and stamping a quantity of combustible material to form a compressed sheet of combustible material, and die cutting the sheet into multiple, individual fuel elements.

According to one embodiment, a method for making a fuel element for a portable stove system includes heating a wax material and mixing a cellulose-containing material with the heated wax material. The method further includes pressurizing the cellulose-containing material and heated wax material mixture. Additionally, the method includes cooling the pressurized cellulose-containing material and heated wax material mixture. The method further includes partitioning the cooled cellulose-containing material and heated wax material mixture into a plurality of fuel elements. Moreover, the method may include wrapping each of the plurality of fuel elements in a combustible wax paper.

In certain implementations, the method also includes transferring the cellulose-containing material and heated wax material mixture into a mold. In the method, pressurizing the cellulose-containing material and heated wax material mixture includes applying pressure to the cellulose-containing material and heated wax material mixture within the mold. The pressurized cellulose-containing material and heated wax material mixture form a column of combustible material. The method can include hardening the column of combustible material within the mold and removing the column of combustible material from the mold. Partitioning the cellulose-containing material and heated wax material mixture can include slicing the removed and hardened column of combustible material into a plurality of fuel elements.

According to some implementations, the method also includes transferring the cellulose-containing material and heated wax material mixture onto a moving surface. In the method, pressurizing the cellulose-containing material and heated wax material mixture includes rolling the cellulose-containing material and heated wax material mixture to form a sheet having an intermediate thickness and stamping the sheet having the intermediate thickness to form a sheet having a final thickness less than the intermediate thickness. Partitioning the cellulose-containing material and heated wax material mixture can include cutting the sheet having the final thickness into a plurality of fuel elements. The method may further include trimming each of the plurality of fuel elements into a polygonal shape.

According to yet another embodiment, a portable fuel system includes a container that includes a closed end and an open end. The system also includes a fuel element that includes a compressed homogenous mixture of a cellulose-containing material and a hardened wax material. The fuel element is removably positionable within the container. The system also includes a spacer that is positionable within the container between the closed end of the container and the fuel element. The spacer supports the fuel element on the closed end such that air is flowable between the fuel element and the closed end. The system further includes a cooking surface that is couplable to the open end of the container.

In some implementations, the system includes a cooking platform that is positionable between the cooking surface and the open end of the container. The cooking platform supports the cooking surface on the open end and includes apertures for facilitating the flow of air into the container.

According to certain implementations, the spacer includes at least one elongate and upright panel. The panel may include a plurality of apertures. In some implementations, the spacer includes an annular ring. The spacer can be adjustable to adjust the amount of oxygen exposed to the fuel element.

The container has an overall height and the fuel element has an overall thickness. In one implementation, a ratio of the overall height of the fuel element and the overall thickness of the fuel element is greater than 1.5. In another implementation, the ratio of the overall height of the fuel element and the overall thickness of the fuel element is greater than about 5 and less than about 10. Further, the container has an inner diameter and the fuel element has an outer diameter. In certain implementations, a ratio of the inner diameter of the container and the outer diameter of the fuel element is greater than 1 and less than about 1.4. According to some implementations, when the fuel element is positioned within the container, a space is defined between an inner diameter of the container and an outer diameter of the fuel element.

Reference throughout this specification to features, advantages, or similar language does not imply that all of the features and advantages that may be realized with the subject matter of the present disclosure should be or are in any single embodiment or implementation of the subject matter. Rather, language referring to the features and advantages is understood to mean that a specific feature, advantage, or characteristic described in connection with an embodiment is included in at least one embodiment of the subject matter of the present disclosure. Discussion of the features and advantages, and similar language, throughout this specification may, but do not necessarily, refer to the same embodiment or implementation.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a perspective exploded view of a portable stove system having a fuel element according to one representative embodiment;

FIG. 2 is a cross-sectional side view of the portable stove system of FIG. 1 in an assembled state;

FIG. 3 is a cross-sectional side view of a casting and pressurization tube for forming a column of combustible material according to one representative embodiment;

FIG. 4 is a side view of a slicing device for slicing individual fuel elements from a column of combustible material according to one representative embodiment;

FIG. 5 is a flow chart diagram depicting a method for making a fuel element according to one representative embodiment;

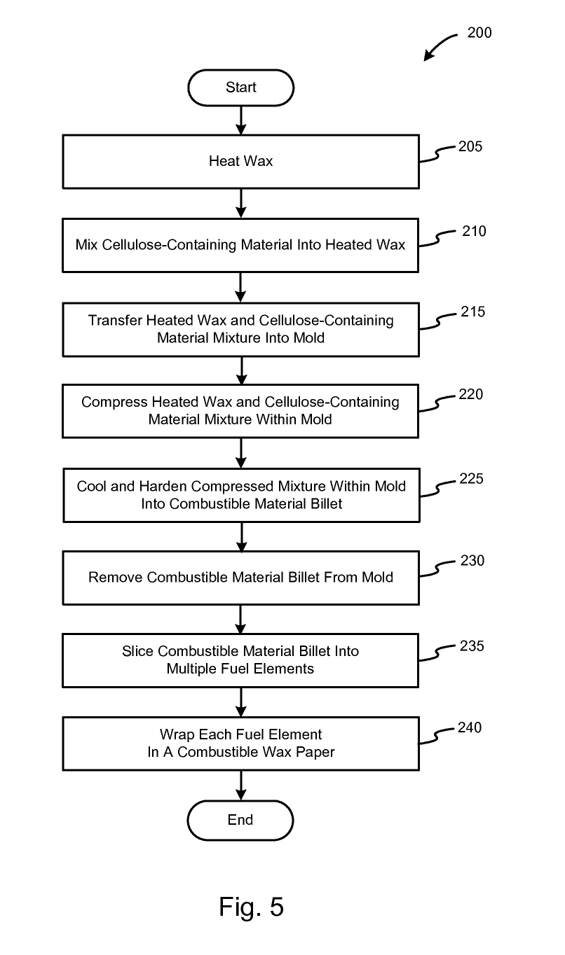

FIG. 6 is a side view of an assembly line for forming a sheet of combustible material according to one representative embodiment;

FIG. 7 is a perspective view of a die cut for cutting a plurality of individual fuel elements from a single sheet of combustible material according to one representative embodiment;

FIG. 8 is a perspective view of a fuel element having trimmed corners to form a substantially octagonal shaped fuel element according to one representative embodiment;

FIG. 9 is a flow chart diagram depicting a method for making a fuel element according to another representative embodiment; and

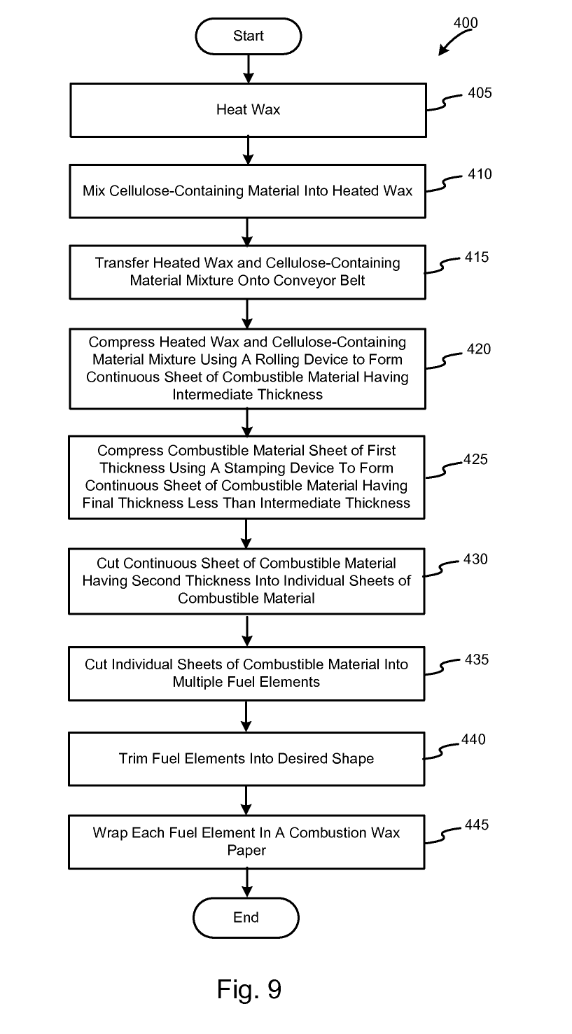

FIG. 10 is a cut-away perspective view of a fuel element covered by a combustible wax paper according to one representative embodiment.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present invention, however, absent an express correlation to indicate otherwise, an implementation may be associated with one or more embodiments.

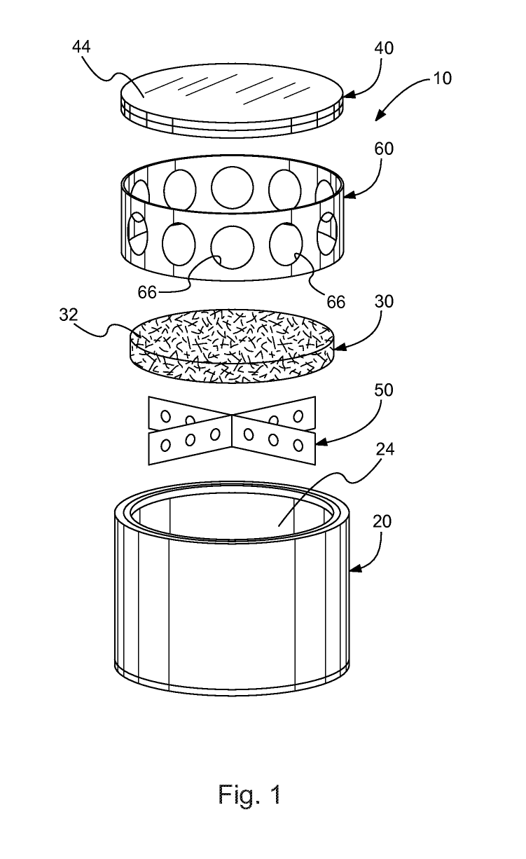

According to one representative embodiment illustrated in FIG. 1, a portable stove system 10 includes a container 20, fuel element 30, and lid 40. The portable stove system 10 also includes a fuel element spacer 50 and a cooking platform 60. Prior to use, the fuel element 30, spacer 50, and cooking platform 60 can be contained within and interior 21 the container 20. To enhance portability, the lid 40 is removably sealed to the container 20 to enclose the fuel element 30, spacer, 50, and cooking platform 60 within the container. Removable sealing between the lid 40 and the container 20 is facilitated by engagement between an upper lip 24 of the container and a groove 42 formed in the lid.

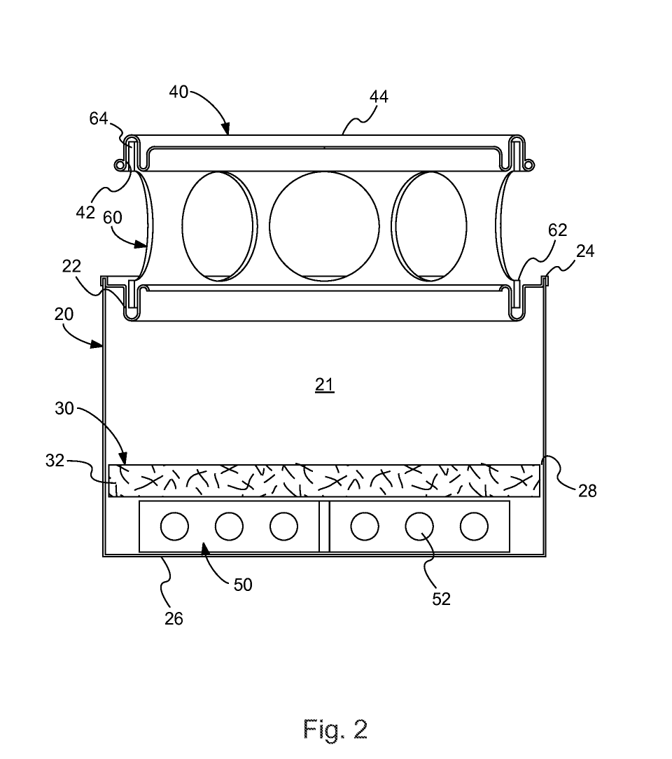

For use, as shown in FIG. 2, the lid 40 and cooking platform 60 can be removed from the container 20 leaving the fuel element 30 and spacer 50 within the container; the spacer being positioned between the fuel element 30 and a closed bottom end 26 of the container. A lower rim 62 of the cooking platform 60 is positioned within an upper groove 22 of the container 20 adjacent an open upper end 24 of the container and the lid 40 is placed atop the cooking platform 60. In this manner, the lid 40 is spaced apart from the container by the cooking platform 60. In certain implementations, the groove 42 of the lid 40 is configured to receive an upper rim 64 of the cooking platform 60 to removably couple the lid to the cooking platform. Although not shown, it is recognized that the cooking platform 60 can include grooves configured to receive rims of the container 20 and lid 40 in other embodiments.

Before or after the cooking platform 60 is positioned atop the container 20, a flame from a fire source (e.g., a lighter, conventional match, waterproof match, etc.) is placed in contact with the fuel element 30 to ignite the fuel element. With the fuel element 30 ignited, the lid 40 can be placed atop the cooking platform 60. Alternatively, the fuel element 30 can be ignited with the lid 40 in place by inserting the flame through apertures 66 in the cooking platform 60. Heat from the ignited and burning fuel element rises to heat the lid 40. Food or liquid items can be placed on a cooking surface 44 of the lid 40 to cook or warm the food or liquid items. To facilitate combustion of the fuel element 30, the apertures of the cooking platform 60 allow for the introduction of oxygen into the container and the dispersement of carbon dioxide, water vapor, and other combustion byproducts from the container.

The spacer 50 facilitates a uniform burning of the fuel element 30 across all surfaces of the element by allowing oxygen to flow underneath the fuel element. Generally, the spacer 50 can be any of various structures configured to elevate the fuel element 30 above the closed bottom end 26 of the container 20 such that a space is positioned between the fuel element and the bottom end of the container. In the illustrated embodiment, the spacer 50 includes a pair of elongate sheet-like strips or panels oriented in an upright manner and arranged in a crisscross configuration to form a generally “X” shape. In some embodiments, the spacer can include a single elongate strip or panel bent or flexed to form an “S” shape, coiled shape, or other curved shape. Alternatively, in other embodiments, the spacer 50 is a ring-like or annular-shaped element with apertures similar to the cooking platform 60 (see, e.g., apertures 52 of FIG. 2). In yet other embodiments, the spacer 50 can include a strip or panel having a signal wave form with alternating peaks and valleys in an elongate direction.

The height of the spacer 50 corresponds with the distance between the fuel element 30 and the bottom end 26 of the container 20, which corresponds with the amount of oxygen available for combustion, and thus the heat output of the fuel element. In one implementation, the spacer 50 has a height of about 0.750 inches such that the distance between the bottom end 26 and the fuel element 30 is about 0.750 inches. In certain implementations, the spacer 50 is substantially rigid and non-adjustable along a height of the spacer to allow a predetermined amount of oxygen below the fuel element 30 and to provide a predetermined heat output.

In certain implementations, the configuration of the spacer 50 can be adjustable to change the heat output of the fuel element 30 for different cooking applications. For example, in one implementation, the height of the spacer 50 is adjustable to increase and decrease the volume of the space between the fuel element and the bottom end of the container, and correspondingly increase and decrease the heat output of the fuel element 30. Alternatively, or additionally, the length of the spacer 50 can be adjusted to adjust the heat output of the fuel element 30. Further, apertures formed in the spacer 50 can be adjusted (e.g., opened or closed) to adjust (e.g., increase or reduce, respectively) the amount of oxygen exposed to a bottom surface of the fuel element 30 and thus respectively raise or lower the heat output of the fuel element 30. In some embodiments, based on the desired application, the heat output of the portable stove system 10 is adjustable by adjusting the size of the fuel element 30 (e.g., replacing a fuel element of a specific size with a fuel element having a different size). For example, for warming a food or liquid, a smaller-sized fuel element 30 can be used. Alternatively, for cooking a food or boiling water, a larger-sized fuel element 30 can be used.

In certain implementations, the fuel element 30 is sized such that a side space 28 exists between an outer circumferential periphery of the fuel element and the inner surface of the container 20 (see, e.g., FIG. 2). In this manner, the fuel element 30 is easily removable from and easily insertable into the container 20 with damaging or deforming the fuel element. For example, in one embodiment, the container 20 has an inner diameter between approximately six inches and seven inches, and the fuel element 30 has a diameter between approximately five inches and six inches (e.g., ratios of the inner diameter of the container to the outer diameter of the fuel element being greater than 1 and less than about 1.4). In one specific implementation, the container 20 has an inner diameter of about 6.625 inches, and the fuel element 30 has a diameter of about 5.250 inches (e.g., a ratio of the inner diameter of the container to the outer diameter of the fuel element being about 1.26). The side space facilitates the flow of oxygen from above the fuel element 30 to below the fuel element and the flow of combustion byproducts from below the fuel element to above the fuel element. The fuel element 30 has a generally disk shape. More specifically, the fuel element 30 has two opposing major surfaces separated from each other by a thickness, which is substantially less than a major dimension of the major surfaces. The ratio of the major dimension of the major surfaces to the thickness of the fuel element 30 can be selected to provide an optimal heat output based on a user's particular needs and/or application.

In the illustrated embodiment, the container 20, fuel element 30, lid 40, and cooking platform 60 have a circular configuration (e.g., each has a circular outer periphery in plan view). More specifically, the illustrated container 20 is substantially tubular with a circular cross-sectional shape, the illustrated fuel element 30 and lid 40 have a generally disk shape, and the cooking platform 60 has a generally annular shape. However, in other embodiments, the container 20, fuel element 30, lid 40, and cooking platform 60 can have a non-circular configuration, such as, for example, an ovular, rectangular, and polygonal (e.g., octagonal) configuration. More specifically, each of the container 20, fuel element 30, lid 40, and cooking platform 60 can have a non-circular outer periphery in plan view. Although conventionally a flame generated by wood products produces less heat output (e.g., BTU) than a gas-generated flame of comparable size, the surface area of a flame generated from a fuel element disk is substantially larger than that of a gas flame. Accordingly, the overall heat output generated by the disk can be comparable to or even greater than a single gas flame or even multiple gas flames.

Regardless of the shape of the outer periphery of the components of the portable stove system 10, the relatively thin and compressed profile of the fuel element 30 enhances the compactness of the system. In other words, because the fuel element 30 is highly compressed into a thin disk, the overall height of the system 10, particularly the height of the container 20, can be reduced for improved portability and storability without losing heat output capability compared to portable stove systems with combustible material formed inside and to the container. In some embodiments, the fuel element 30 has a disk shape with a diameter between about 1.5 inches and about 10 inches and a thickness between about 0.250 inches and about 2.0 inches. In certain embodiments, the fuel element 30 has a disk shape with a diameter between about 4.5 inches and about 5.5 inches, and a thickness between about 0.5 inches and about 1.0 inches. In one illustrative embodiment, the diameter of the fuel element 30 is about 5.25 inches and the thickness of the fuel element is about 0.75 inches (e.g., a diameter to thickness ratio of 7). In certain embodiments, the height of the container 20 is between about 3 inches and about 6 inches. In one particular implementation, the height of the container 20 is about 4 inches. Accordingly, a ratio of the height of the container 20 to the thickness of the fuel element can be between about 1.5 and about 24. In certain implementations, the ratio of the height of the container 20 to the thickness of the fuel element is greater than about 5, but less than about 10. In one implementation, the ratio of the height of the container 20 to the thickness of the fuel element is about 5.

The fuel element 30 can have any of various weights. In certain embodiments, the weight of the fuel element 30 is between about 7 ounces and about 9 ounces. In one illustrative embodiment, the weight of the fuel element 30 is about 8 ounces.

The fuel element 30 is made from a compressed combustible material 32. The combustible material 32 of the fuel element 30 includes a combination of a cellulose-containing material and a wax material. In some embodiments, the combustible material 32 includes between about 30% and 70% cellulose-containing material and between about 30% and 70% wax material. In certain implementations, the combustible material 32 includes about 50% cellulose-containing material and about 50% wax material. The relative percent composition of the cellulose-containing material and the wax material may be dependent upon the size and type of cellulose-containing material used. For example, because larger pieces of cellulose-containing material absorb more wax, the larger the individual pieces of cellulose-containing material, the higher the percent composition of wax material. Alternatively, the smaller the individual pieces of cellulose-containing material, the smaller the percent composition of wax material.

In certain embodiments, the cellulose-containing material includes a wood product, such as, for example, wood shavings and sawdust. The wood product can be made from any of various hard and/or soft woods. In certain implementations, the wood product is made from a hard wood (e.g., hickory, mesquite, maple, and oak), a soft wood (e.g., pine), or a combination of both. Generally, the wood product is selected to provide high heat and easy ignition. In some implementations, the wood product includes about 70% hard wood shavings to facilitate high heat and about 30% soft wood shavings to facilitate easy ignition. The wood product shavings can have any of various shapes and sizes. Preferably, however, the wood product shavings each have a major dimension that is between about 0.250 inches and 0.375 inches. In certain implementations, at least one of hard wood and soft wood sawdust is added to the wood product shavings to enhance the ignitability of the fuel element 30. Further, in some implementations, an artificial flavor or aroma can be added to the wood product to enhance the flavor of the food or beverage being warmed or cooked by the portable stove system.

Preferably, the wax material of the combustible material 32 includes a food-grade wax. As defined herein, food-grade wax is a wax having less than a 0.8% concentration of oil. In some embodiments, the wax material includes at least one of an artificial wax (e.g., paraffin wax) and a natural wax (e.g., beeswax and soy wax). Desirable natural waxes can be refined or unrefined. In certain embodiments, the fuel element 30 is made from about 50% hard wood shavings and about 50% naturally occurring wax, such as beeswax.

Generally, a fuel element (e.g., fuel element 30) described herein is made by mixing a desired portion of the cellulose-containing material with a desired portion of heated wax material. The resultant mixture is pressurized and cooled to allow the wax material to harden. The hardened mixture is then partitioned into multiple fuel elements.

According to one embodiment shown in 5, a method 200 for making a fuel element (e.g., fuel element 30) includes heating a desired amount and type of wax material at 205 to liquefy the wax material. The wax material can be heated in any of various containers using any of various heating methods. For example, solid wax can be placed in a mixing container, which is placed in a heated oven or over a heat source, such as a flame or burner. After a period of time based on the intensity of the heat, the solid wax material melts into a liquid state. When the wax material is in the liquid state (e.g., when warm or hot), a desired amount of cellulose-containing material is dispensed into the mixing container and mixed with the wax material at 210. The cellulose-containing material is mixed with the wax material until the mixture is substantially homogenized.

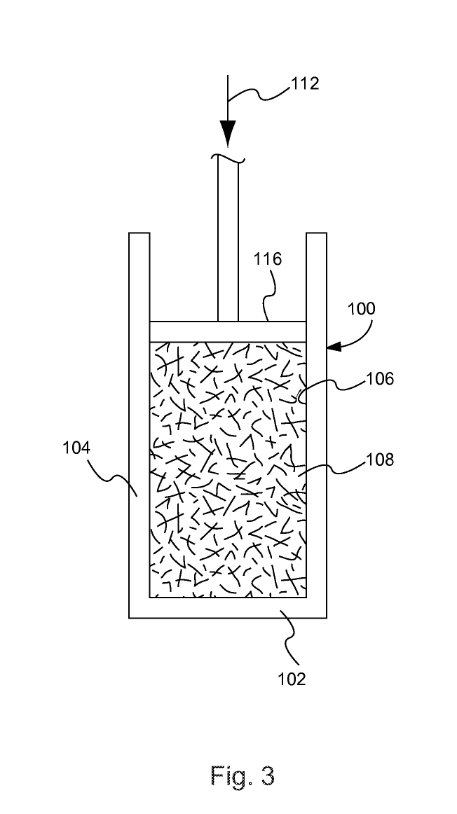

The homogenized mixture of cellulose-containing and wax materials is transferred into a mold at 215. The mold can be the mold 100 of FIG. 3. The mold 100 includes a rigid end wall 102 and side wall 104 that defines a generally cylindrically shaped interior cavity 106. The mixture 108 of cellulose-containing and wax materials is transferred (e.g., poured) into the interior cavity 106 while the wax material is warm. After being poured into a mold (e.g., the interior cavity 106 of the mold 100), the method 200 includes compressing the mixture at 220. In certain implementations, the mixture (e.g., mixture 108) is compressed using a compression device having a piston 110 that compresses the mixture within the interior cavity 106. To compress the mixture 108, the compression device, which can be a pneumatic, electric, hydraulic, or magnetic actuator, moves the piston 110 in a direction as indicated by directional arrow 112.

The amount of compression undergone by the mixture 108 is based on the amount of pressure applied to the mixture by the piston 110. Generally, the higher the compression of the mixture 108 the longer the compressed combustible material mixture burns, the more water resistant the fuel element, and the better the fuel element is able to retain its shape, but the lower the heat generated by the burning combustible material mixture and the harder the fuel element is to ignite. Accordingly, the amount of pressure applied to the mixture 108 by the piston 110 should be carefully selected to achieve a pressurization of the combustible material mixture that results in a desired burn length, water resistibility, shape retaining capacity, ignitibility, and heat generation.

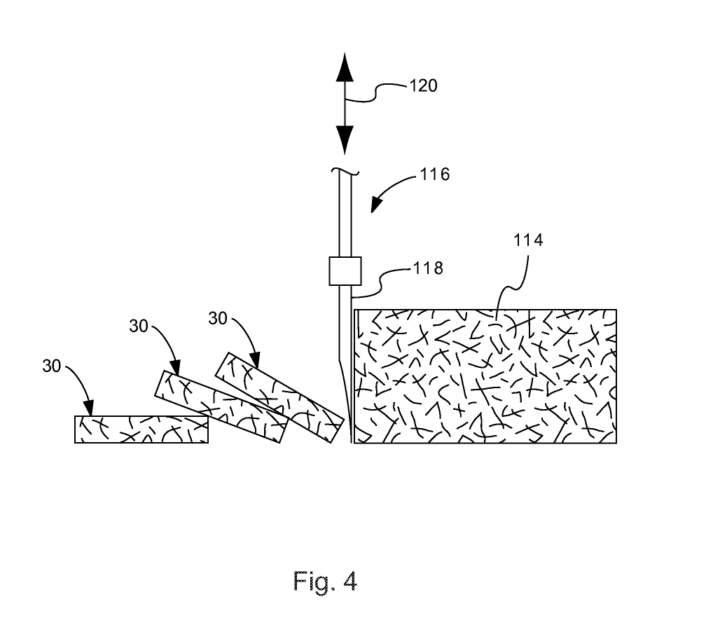

Following compression of the mixture at 220, the method 200 includes cooling and hardening the mixture within the mold to form a combustible material billet at 225. In the specific embodiment of FIG. 3, the compressed mixture 108 is allowed to cool within the interior cavity 106 of the mold 100. As the mixture 108 cools, the wax material hardens such that the overall shape of the compressed mixture 108 conforms to the shape of the interior cavity 106. In the illustrated embodiment, the resultant shape of the cooled and hardened compressed mixture 108 is generally cylindrical or column-like. The combustible material billet (e.g., combustible material billet 114 of FIG. 4) is removed from the mold at 230 of the method 200 and sliced into multiple fuel elements at 235 of the method. In one specific application of the method 200, the combustible material billet 114 is sliced into multiple individual fuel elements 30 using a slicing device 116. The slicing device 116 includes a blade 118 that is actuated away from and toward the combustible material billet 114 as indicated by directional arrow 120. As the blade 118 is actuated toward the billet 114, the blade 118 cuts through the billet at a predetermined distance away from an end of the billet to form an individual fuel element 30 having a predetermined thickness. In certain implementations, the billet 114 is held stationary and the blade 118 is incrementally moved relative to the billet to slice the billet at specified increments along the length of the billet. In other implementations, the blade 118 is held horizontally stationary and the billet 114 is moved relative to the blade.

After the combustible material billet is sliced into at least one fuel element at 235, the fuel element is wrapped (e.g., covered or enveloped) in a combustible wax paper at 240 of the method 200. In some embodiments, a sheet of combustible wax paper is wrapped around a fuel element and coupled to itself to fully enclose the fuel element using any of various adhesion techniques. In one specific embodiment, after wrapping the sheet of combustible wax paper around the fuel element, respective edges or portions of the sheet of combustible wax paper are bonded to each other by heating the paper, allowing the wax from the edges or portions to bond together, and cooling the paper.

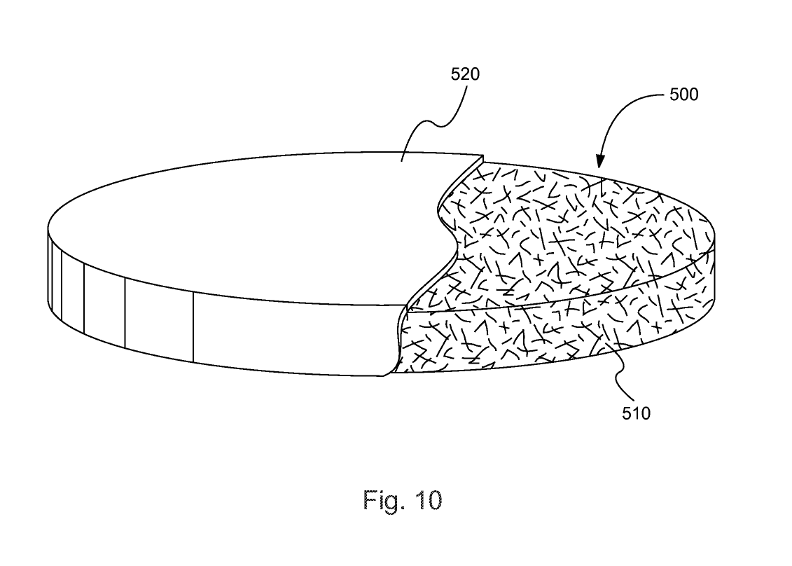

According to one specific embodiment shown in FIG. 10, a fuel element 510 is wrapped in a combustible wax paper 520 to form a fuel element package 500. Fuel element package 500 can be more easily protected from the elements, marked, handled, and ignited compared to fuel elements without a combustible wax paper covering. During use, the combustible wax paper 520 of the fuel element package 500 initially is ignited. The underlying fuel element 510 subsequently is ignited by the burning combustible wax paper. The combustible wax paper 520 is configured to burn slower than standard paper such that ignition and combustion of the wax paper ensure ignition and combustion of the fuel element 510. The combustible wax paper 520 can be made from any of various wax papers. In specific implementations, the combustible wax paper 520 is made from a recycled wax paper.

According to one embodiment shown in 9, another method 400 for making a fuel element (e.g., fuel element 30) includes heating a desired amount and type of wax material at 405 to liquefy the wax material. The wax material can be heated in a manner similar to action 205 of method 200. When the wax material is in the liquid state, a desired amount of cellulose-containing material is dispensed into the mixing container and mixed with the wax material at 410 in a manner similar to action 210 of method 200.

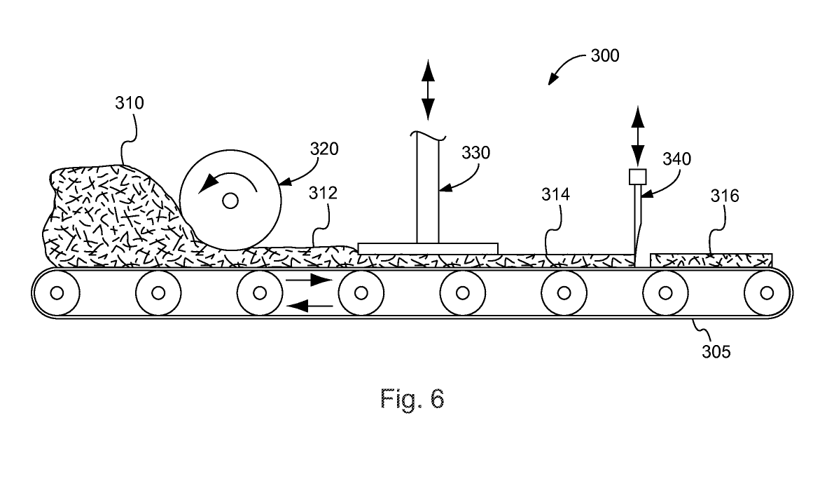

While the wax is warm, the mixture of cellulose-containing and wax materials is transferred into a movable surface (e.g., a conveyor belt) at 415. FIG. 6 illustrates one representative embodiment of a conveyor belt 305 of a combustible material sheet forming system 300 that can be used to implement step 415 of method 400. As shown, a warm mixture 310 of cellulose-containing and wax materials is transferred onto and accumulates on a moving surface of the conveyor belt 305. According to method 400, the transferred mixture is compressed using a rolling device to form a continuous sheet of combustible material having an intermediate thickness. In the illustrated embodiment, the system 300 includes a roller 320 that rolls in the indicated direction (e.g., counter-clockwise as shown). In conjunction with the moving conveyor belt 305, the roller 320 compresses the mixture 310 between the roller and conveyor belt to form a continuous sheet 312 of combustible material.

The continuous sheet of combustible material with the intermediate thickness is further compressed using a stamping device to form a continuous sheet of combustible material with a final thickness that is less than the intermediate thickness as step 425 of the method 400. In the illustrated embodiment of FIG. 6, the system 300 includes a stamping device 330 that is actuatable toward and away from the conveyor belt 305 in the indicated direction. When actuated toward the conveyor belt 305, the stamping device 330 compresses the continuous sheet 312 against the conveyor belt to form a continuous sheet 314 of combustible material having the final thickness. The amount of pressure applied to the continuous sheet 312 by the stamping device 330 can be selected according to a desired burn length and intensity of the combustible material as described above.

The continuous sheet of combustible material with the final thickness is cut into individual sheets of combustible material at step 430 of method 400. In the illustrated embodiment of FIG. 6, the system 300 includes a cutting device 340 having a blade that is actuated toward and away from the conveyor belt 305 in the indicated direction. When actuated toward the conveyor belt 305, the blade of the cutting device 340 cuts the continuous sheet 314 into individual sheets 316 of a predetermined length.

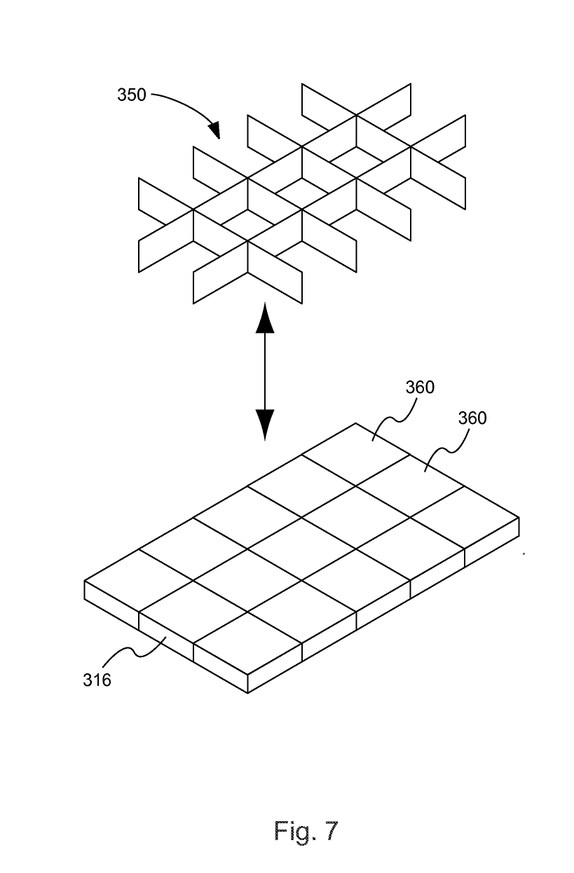

Each individual sheet of combustible material is cut into multiple fuel elements at step 435 of method 400. Each fuel element can then be trimmed into a desired shape at step 440 of method 400. In the illustrated embodiment of FIG. 7, step 435 of method 400 can be implemented by cutting an individual sheet 316 of combustible material a die cut 350. The die cut 350 includes a plurality of interconnected blades configured to cut multiple identical fuel element blocks 360 each with a specific shape (e.g., square shape as shown). The process of cutting the individual sheet 316 with die cut 350 can be automated such that the die cut 350 actuates toward and away from the conveyor belt 305 in the indicated direction. As the die cut 350 actuates toward the conveyor belt 305, the die cut cuts through the individual sheet 316 while it is supported by the conveyor belt. Alternatively, each individual sheet 316 can be removed from the conveyor belt 305, allowed to cool and harden, and then cut with the die cut 350 at a station separate from the conveyor belt.

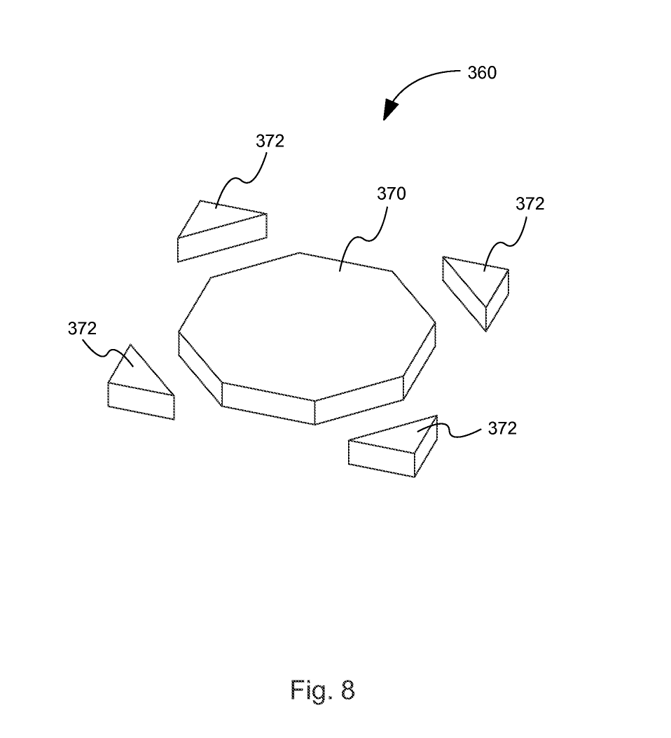

In the illustrated embodiment of FIG. 8, after the fuel element blocks 360 are cut, each block can be trimmed into a fuel element 370 having a desired shape by removing portions 372 of the block. As illustrated, the portions 372 include corners of the fuel element block 360 and the desired shape of the fuel element 370 is octagonal. Alternatively, the die cut 350 can be shaped to cut the sheet 316 of combustible material into the desired shape (e.g., octagonal, circular, etc.) without further trimming of the block.

Similar to step 240 of method 200, the method 400 includes wrapping the fuel element in the desired shape (e.g., fuel element 360) in a combustible wax paper at 445.

The subject matter of the present disclosure may be embodied in other specific forms without departing from its spirit or essential characteristics. The described embodiments are to be considered in all respects only as illustrative and not restrictive. The scope of the subject matter of the present disclosure is, therefore, indicated by the appended claims rather than by the foregoing description. All changes which come within the meaning and range of equivalency of the claims are to be embraced within their scope.

What is claimed is:

1. A method for making a fuel element for a portable stove system, comprising:
heating a wax material;
mixing a cellulose-containing material with the heated wax material;
pressurizing the cellulose-containing material and heated wax material mixture;
cooling the pressurized cellulose-containing material and heated wax material mixture; and
partitioning the cooled cellulose-containing material and heated wax material mixture into a plurality of fuel elements.

2. The method of claim 1, further comprising transferring the cellulose-containing material and heated wax material mixture into a mold, and wherein pressurizing the cellulose-containing material and heated wax material mixture comprises applying pressure to the cellulose-containing material and heated wax material mixture within the mold, the pressurized cellulose-containing material and heated wax material mixture forming a column of combustible material.

3. The method of claim 2, further comprising hardening the column of combustible material within the mold and removing the column of combustible material from the mold, wherein partitioning the cellulose-containing material and heated wax material mixture comprises slicing the removed and hardened column of combustible material into a plurality of fuel elements.

4. The method of claim 1, further comprising transferring the cellulose-containing material and heated wax material mixture onto a moving surface, and wherein pressurizing the cellulose-containing material and heated wax material mixture comprises rolling the cellulose-containing material and heated wax material mixture to form a sheet having an intermediate thickness and stamping the sheet having the intermediate thickness to form a sheet having a final thickness less than the intermediate thickness.

5. The method of claim 4, wherein partitioning the cellulose-containing material and heated wax material mixture comprises cutting the sheet having the final thickness into a plurality of fuel elements.

6. The method of claim 4, further comprising trimming each of the plurality of fuel elements into a polygonal shape.

7. The method of claim 1, further comprising wrapping each of the plurality of fuel elements in a combustible wax paper.

8. A fuel element for a portable stove system, comprising:
a homogenous mixture of a cellulose-containing material and a hardened wax material, the homogenous mixture having a substantially disk shape; and
a cover wrapped about the homogenous mixture, the cover comprising a combustible wax paper.

9. The fuel element of claim 8, wherein the cellulose-containing material comprises hard wood shavings and the hardened wax material comprises a naturally occurring wax.

10. The fuel element of claim 9, wherein the naturally occurring wax comprises beeswax.

11. A portable fuel system, comprising:
a container comprising a closed end and an open end;
a fuel element comprising a compressed homogenous mixture of a cellulose-containing material and a hardened wax material, the fuel element being removably positionable within the container;
a spacer positionable within the container between the closed end of the container and the fuel element, the spacer supporting the fuel element on the closed end such that air is flowable between the fuel element and the closed end; and
a cooking surface couplable to the open end of the container.

12. The portable fuel system of claim 11, further comprising a cooking platform positionable between the cooking surface and the open end of the container, the cooking platform supporting the cooking surface on the open end and comprising apertures for facilitating the flow of air into the container.

13. The portable fuel system of claim 11, wherein the spacer comprises at least one elongate and upright panel.

14. The portable fuel system of claim 13, wherein the at least one elongate and upright panel comprises a plurality of apertures.

15. The portable fuel system of claim 11, wherein the spacer comprises an annular ring.

16. The portable fuel system of claim 11, wherein the container has an overall height and the fuel element has an overall thickness, and wherein a ratio of the overall height of the fuel element and the overall thickness of the fuel element is greater than 1.5.

17. The portable fuel system of claim 16, wherein the ratio of the overall height of the fuel element and the overall thickness of the fuel element is greater than about 5 and less than about 10.

18. The portable fuel system of claim 11, wherein the container has an inner diameter and the fuel element has an outer diameter, and wherein a ratio of the inner diameter of the container and the outer diameter of the fuel element is greater than 1 and less than about 1.4.

19. The portable fuel system of claim 11, wherein when the fuel element is positioned within the container, a space is defined between an inner diameter of the container and an outer diameter of the fuel element.

20. The portable fuel system of claim 11, wherein the spacer is adjustable to adjust the amount of oxygen exposed to the fuel element.
